(19) United States
(12) Patent Application Publication
(10) Pub. No.: US 2006/0108877 A1
(43) Pub. Date: May 25, 2006

(54) Extensible coil for biaxial driver

(76) Inventor: Robert George Tegel, Huntley, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 10/405,183

(22) Filed: Apr. 2, 2003

Related U.S. Application Data
(60) Provisional application No. 60/413,224, filed on Sep. 24, 2002.

(51) Int. Cl. H02K 41/00

(52) U.S. Cl. 310/12

(57) ABSTRACT

A biaxial driver includes an induction coil that is moveable in two dimensions and a linearly oriented magnet. A payload platform for holding a tool or workpiece is attached to the moveable coil. The inventive driver provides motion parallel to an axis of the magnet, even while the coil is moved transversely or obliquely to the axis of the coil, and permits the degree of coil extension to be varied while the biaxial driver is operated. Because the magnet is held stationary during movement of the payload platform, there is no inertia from the stationary magnet to overcome. A result, the payload platform can be moved from one position to another in less time, the payload platform can carry a more massive payload than previous positioning drivers and the invention requires less energy consumption.

This application claims the benefit of and right of priority from U.S. Provisional Patent Application Ser. No. 60/413,224, filed Sep. 24, 2002, which is hereby incorporated by reference.

The invention relates generally to planar motors and, more specifically, to a biaxial driver for driving a movable platform used to transfer or position a tool or workpiece.

### FIELD OF THE INVENTION

### Background of the Invention

Previously known devices for positioning a platform along a single axis are often termed “linear drivers” and include various mechanisms capable of producing linear motion, such as a piston, a rotating screw thread and threaded collar or a mechanical linkage, among others. For example, the linear driver may be actuated by a linear electric motor including a stationary magnet and a movable coil or a movable magnet and a stationary coil. The movable coil or movable magnet travels in a line, and is said to have one degree of freedom, because it is movable along a single axis (hereinafter referred to as “the first axis”). The movable coil or movable magnet is supported by a bearing that glides on a stationary guide rail, which defines the first axis. A platform for mounting a tool or workpiece is usually attached to the movable coil or movable magnet and/or the bearing. An example of a linear electric motor is described in U.S. Pat. No. 5,998,890, issued to Sedgewick et al., which is hereby incorporated by reference.

Previously known devices for positioning a platform along two crossing or intersecting axes are termed “biaxial” or “planar drivers.” The biaxial driver may be, for example, a checkerboard magnet array and coil arrangement, as described in U.S. Pat. No. 6,097,114, issued to Hazelton, which is hereby incorporated by reference. As another example, the biaxial driver may include two moving coil linear electric motors, each as described above, joined head-to-tail so that the platform of the first motor supports the magnet of the second motor. The second motor positions a second platform along a second axis (hereinafter referred to as “the second axis”), which is often arranged perpendicularly to the first axis. This head-to-tail concept can also be applied to three linear motors in a multi-axial driver for positioning a platform according to any three dimensional, Cartesian coordinates in a specified volume.

While the head-to-tail multiaxis linear motor driver with movable coils is known, it requires that the second motor magnet move in tandem with first motor platform and coil. Because the magnets are often the most massive components of the biaxial driver, the inertia of the second motor magnet significantly impedes movement of the first motor coil and platform. Although more powerful motors and more sensitive controllers can alleviate this problem to some extent, the additional inertia due to moving the second motor magnet tends to make the head-to-tail biaxial driver operate in a relatively inefficient manner. Also, the inertia of the second motor magnet exerts dynamic forces on the first motor bearing that require the first motor bearing construction to be more complex and expensive than would otherwise be necessary.

A need exists for a new biaxial driver that does not require a checkerboard magnet array, or a second magnet that must be moved each time a payload platform is moved along the first axis. Desirably, a new biaxial driver could be utilized with a combination of one or more linear drivers and one or more nonlinear drivers.

### SUMMARY OF THE INVENTION

The invention is a biaxial driver including a magnet assembly for producing a magnetic field arranged along a longitudinal axis and a coil assembly. When the coil assembly is under the influence of the magnetic field, and when the coil is electrically energized, the coil has two degrees of freedom. The coil assembly interacts with the magnetic field to produce a motive force generally parallel to the longitudinal axis. The biaxial driver also includes a cross driver for moving the coil assembly or the magnet assembly along an axis that crosses the longitudinal axis. Under the influence of the motive force and the cross driver, the coil assembly or the magnet assembly can be maneuvered throughout a planar area, rather than being confined to a single axis.

In some embodiments of the invention, the cross driver is a linear driver for moving the coil assembly or the magnet assembly along the crossing axis. These two axes define a plane in which the second coil assembly or the magnet assembly, and an associated payload platform, can be accurately and reproducibly positioned. The linear driver may be, for example, a linear electric motor including a magnet assembly that remains at rest.

In other embodiments of the invention, the cross driver is a nonlinear driver such as, for example, a pair of pivoting links, a cam surface and follower, or a tongue and guide groove. These embodiments can be used for, among other things, directing a glue nozzle over an irregular path or area.

The invention provides a motive force parallel to the longitudinal axis of a magnet. The coil assembly sustains the motive force while the coil assembly extends to various distances from the longitudinal axis. The coil assembly is shaped and proportioned to facilitate moving the coil assembly along another axis that crosses or intersects the longitudinal axis during operation.

Additionally, the invention positions a platform in two dimensions. The driver includes a payload platform stationary magnet assembly, which would previously have contributed to the inertia of payload platform movement. With less inertia, the payload platform can be moved from one position to another in less time than prior platform positioning drivers. A further benefit is greater energy efficiency due to lower power consumption. Also, the payload platform can carry a more massive payload than before, for a given coil assembly and magnet assembly. The invention can be applied to two- and three-axis positioning drivers.

### BRIEF DESCRIPTION OF THE DRAWINGS

FIG. 1 is a perspective view of a linear driver of the prior art;

FIG. 2 is a perspective view of a biaxial driver of the prior art;

FIG. 3 is a perspective view of a biaxial driver of the present invention including a linear electric motor;

FIG. 4 is a perspective view of a biaxial driver of the present invention including a piston and cylinder;

FIG. 5 is a perspective view of a biaxial driver of the present invention including a mechanical linkage;

FIG. 6 is an elevation view of a biaxial driver of the present invention including a pair of pivoting links;

FIG. 7 is a cross-sectional view taken along line D-D of FIG. 6, showing a coil assembly of the present invention extended in an intermediate position with respect to a magnet assembly;

FIG. 8 is a cross-sectional view showing the coil assembly of FIG. 6 minimally extended with respect to the magnet assembly;

FIG. 9 is a cross-sectional view showing the coil assembly of FIG. 6 greatly extended with respect to the magnet assembly;

FIG. 10 is a cross-sectional view taken along line E-E of FIG. 9, showing the arrangement of nonoverlapping, polyphasic coil loops in the energizable portion of the coil assembly;

FIG. 11 is an elevation view of a biaxial driver of the present invention including a cam and a follower;

FIG. 12 is an elevation view of a biaxial driver of the present invention including a serpentine groove and a tongue;

FIG. 13 is a perspective view of a coil and moving magnet assembly of the present invention;

FIG. 14 is a cross-sectional view taken along line F-F of FIG. 13; and

FIG. 15 is a cross-sectional view of the coil assembly and the magnet assembly of FIG. 1.

### DETAILED DESCRIPTION OF THE INVENTION

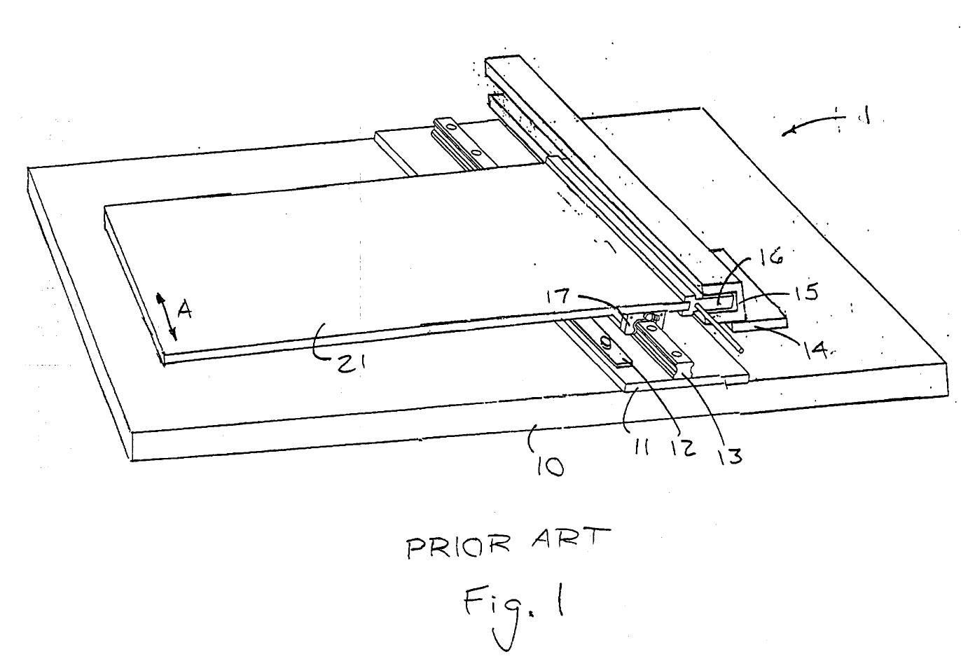

A representative single-axis linear driver of the prior art, designated driver 1, is depicted in FIG. 1. Stationary base 10 is rigidly attached to stationary platform 11. Sensor 12 is fixed to the platform 11 for determining the relative position for an encoder (not shown) to provide feedback for a positioning controller (not shown). Pad 14 secures stationary, channel-shaped magnet 15 to base 10. Coil 16 moves only along a single axis (hereinafter referred to as “the first axis”) along axis A. Bearing 17, which rides on guide rail 13 (shown in FIG. 1), supports coil 16. First platform 21 is fixed to bearing 17 and coil 16. The encoder (not shown) that cooperates with sensor 12 is mounted on platform 21. Platform 21 may be used, for example, to transfer or position a tool or workpiece along the first axis. A tool or workpiece mounted on platform 21 can be moved along the first axis for interaction with another workpiece or tool (such as in an assembly line) by moving platform 21 under the power of the coil and magnet, according to well-known principles.

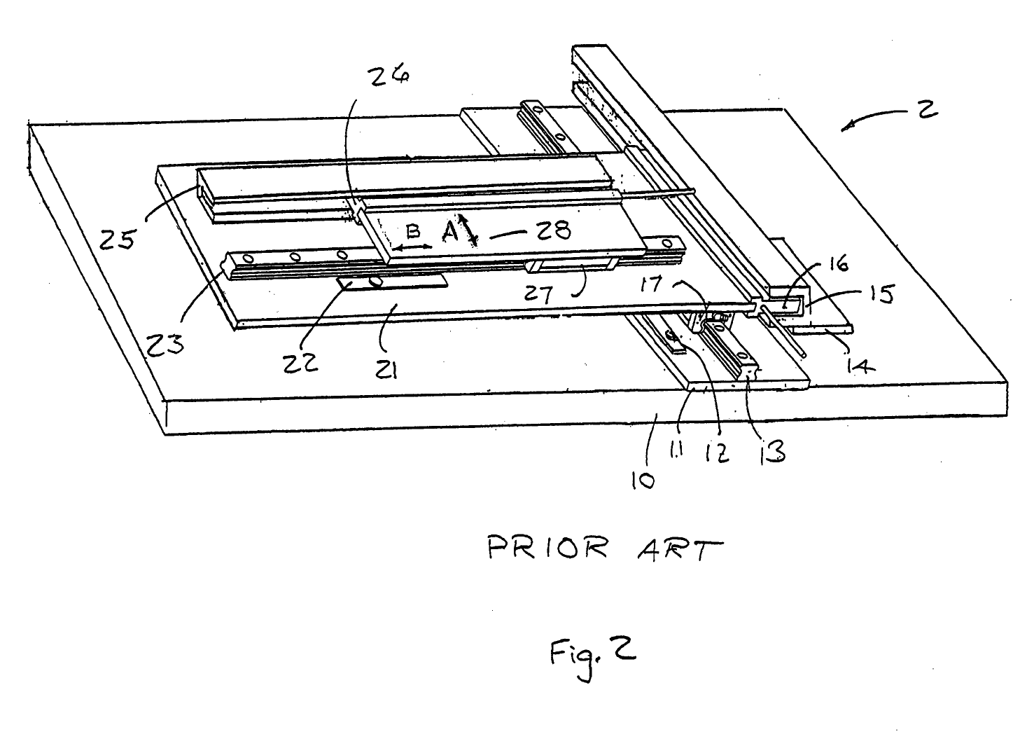

A representative two-axis, head-to-tail driver of the prior art, designated driver 2, is depicted in FIG. 2. Driver 2 includes all of the elements described above with regard to driver 1. Additionally, driver 2 includes sensor 22, guide rail 23 and magnet 25, all attached to platform 21. When platform 21 translates along the first axis in response to movement by coil 16, sensor 22, guide rail 23 and magnet 25 translate along the first axis as well. Driver 2 also includes coil 26, which is attached to bearing 27 and payload platform 28. Bearing 27 glides along guide rail 23 in response to any movement of coil 26 along the second axis parallel to axis B. Significantly, platform 28 and coil 26 remain at a fixed distance from magnet 25. Accordingly, driver 2 can position platform 28 along the first axis and the second axis. Platform 28 is said to have two degrees of freedom.

The head-to-tail multiaxis linear motor driver requires moving magnet 25 in tandem with platform 21 and coil 16. Because magnet 25 is usually one of the most massive components of driver 2, its presence adds a significant amount of inertia to coil 16 movement. Each time payload 28 is accelerated and decelerated in either direction along the first axis, the inertia of magnet 25 must be overcome. Although more powerful motors and more sensitive controllers can alleviate this problem to some extent, the additional inertia due to moving magnet 25 tends to make driver 2 operate in a relatively inefficient manner. The inertia and weight of magnet 25 exert dynamic forces on bearing 17, requiring that bearing 17 be more complex and expensive than would otherwise be necessary.

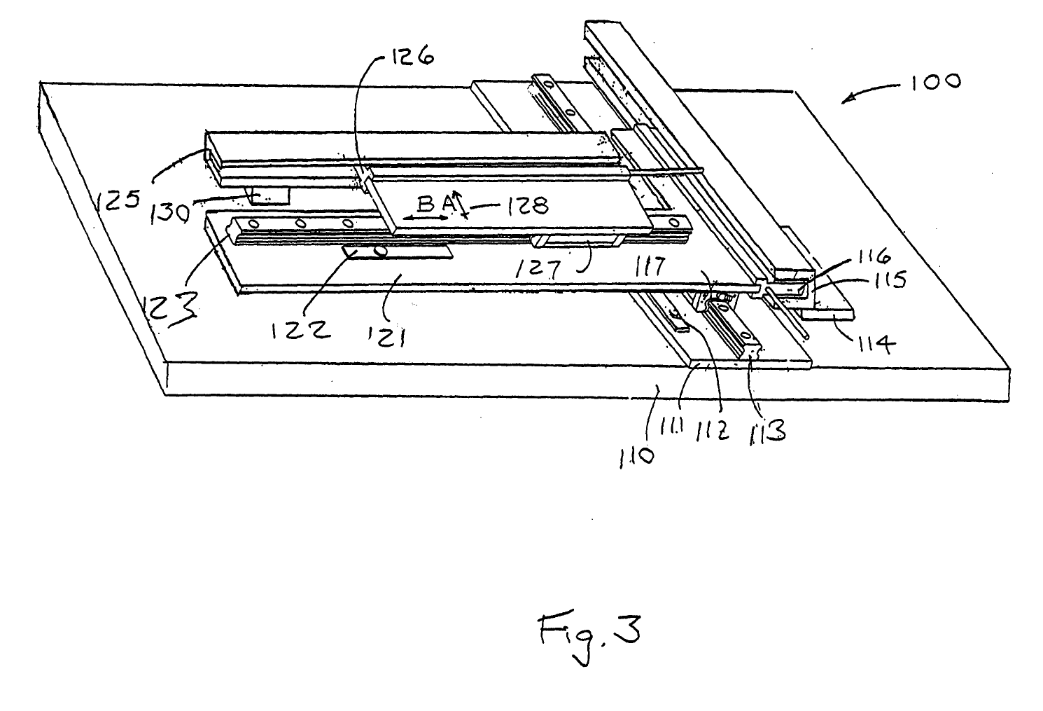

A preferred embodiment of the inventive biaxial driver is driver 100, depicted in FIG. 3. Components depicted in FIG. 3 that have the same two final digits as components depicted in FIGS. 1 and 2 correspond to those components and to the same descriptions of those components (i.e., component 10 of FIG. 1 is the same as component 110 of FIG. 3, component 11 of FIG. 1 is the same as component 111 of FIG. 3, etc).

Driver 100 includes a stationary base 110 that provides mechanical support for the other components of driver 100. Stationary base 110 is rigidly attached to stationary platform 111. Guide rail 113 is secured to base 110, for supporting bearing 117 and moveable platform 121.

Sensor 112 is fixed to the platform 111 for determining its position relative to that of an encoder (not shown). For example, the sensor 112 may include a read head member that determines the position of platform 121 relative to platform 111 and provides feedback for a positioning controller (not shown). Preferably, the encoder (not shown) is an optical scale attached to the underside of platform 121. The positioning controller (not shown) receives a target position as input, compares the present position of payload platform 128 as indicated by sensor 112, and sends electrical power to coil assembly 116 and/or coil assembly 126 as necessary to move payload platform 128 to the target position.

Pad 114 secures stationary, channel-shaped magnet assembly 115 to base 10. The longitudinal axis of magnet assembly 115 defines the first axis of driver 100 for movement parallel to axis A in FIG. 3. Another pad 130 secures stationary, channel-shaped magnet assembly,125 to base 10. The longitudinal axis of magnet assembly 125 defines the second axis of driver 100 for movement parallel to axis B in FIG. 3. As can be inferred from FIG. 3, the first and second axes are perpendicular to each other when the depicted embodiment is viewed in two dimensions from above but are generally not co-planar. In contrast, axes A and B are generally coplanar and cross or intersect each other. The invention can be practiced successfully when axes A and B intersect at any angle other than 0 or 180 degrees, preferably at an interior angle of about 1 to about 90 degrees.

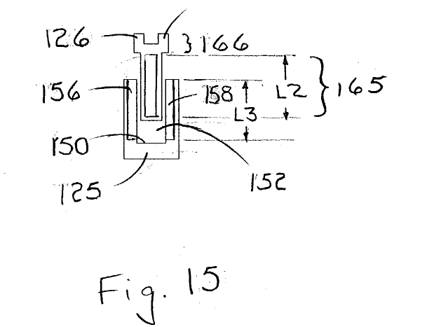

A first linear motor includes coil assembly 116 and magnet assembly 115, as depicted in cross-section in FIG. 15. Magnet assembly 125 includes a yoke supporting two magnet rows 156, 158, which are constituted by permanent magnets arranged with alternating polarity. The yoke is generally U-shaped and forms floor 150 between the magnet rows 156, 158. Coil assembly 126 is inserted between magnet rows 156, 158 with an air gap 152 between coil assembly 126 and floor 150. The vertical length of energizing portion 165 is indicated by length L2 in FIG. 15. The length of magnet rows 156, 158 is indicated by length L3. Coil assembly 116 moves forward and back parallel to axis A under the influence of magnet assembly 115. For example, a coil assembly and a magnet assembly suitable for use in the present invention are commercially available from Anorad Corporation of Shirley, N.Y. as part no. LEB-S-6-S-NC-TE-C and part no. LEB-S-750, respectively.

Referring again to FIG. 3, bearing 117, which rides on guide rail 113, supports coil assembly 116. First platform 121 is fixed to bearing 117 and coil assembly 116 so that as coil assembly 116 moves parallel to axis A, so does first platform 121. The encoder (not shown) that cooperates with sensor 121 is mounted on the underside of platform 121. Platform 121 may be used, for example, to transfer or position a tool or workpiece along axis A.

Driver 100 also includes sensor 122, guide rail 123 and magnet assembly 125, all attached to platform 121. When platform 121 translates along axis A in response to movement by coil assembly 116, sensor 122 and guide rail 123 translate along the first axis as well. Magnet assembly 125 is mounted rigidly to base 110 and does not translate.

A second linear motor includes coil assembly 126 and magnet assembly 125. Coil assembly 126 moves forward and back parallel to axis B under the influence of magnet assembly 125. Additionally, coil assembly 126 moves forward and back parallel to axis A under the influence of coil assembly 116 and magnet assembly 115. The ability of coil assembly 126 to move in two axes eliminates any need for movement of magnet assembly 125 relative to base 110, at least over a significant range of distances. Desirably, coil assembly 126 moves forward and back up to about 10 millimeters along axis A using conventional, commercially available linear motor coil assemblies and magnet assemblies. This amount of extension and retraction is sufficient for many commercially important positioning applications. As will be discussed below, coil assemblies and magnet assemblies can be adapted to provide greater ranges of movement along axis A.

Coil assembly 126 is attached to bearing 127 and payload platform 128. Bearing 127 and payload platform 128 glide along guide rail 123 in response to movement of coil assembly 126 along axis B. An encoder (not shown) that cooperates with sensor 122 is mounted on the underside of payload platform 128. Guide rail 123 and payload platform 128 move along the first axis A in response to movement of coil assembly 116 along the first axis. Accordingly, driver 100 can position payload platform 128 over significant ranges of distance along the first axis and the second axis and within the plane defined by axes A and B. By controlling the timing and the amount of power that the positioning controller (not shown) sends to coil assembly 116 and coil assembly 126, respectively, payload platform 128 can be made to trace any two-dimensional pattern imaginable within the biaxial travel limits of coil assembly 126.

The intensity of the magnetic field in which coil assembly 126 operates decreases as coil assembly 126 moves away from magnet assembly 125. Accordingly, magnet assembly 125 should be suitable for providing a magnetic field intensity that is sufficient to operate coil assembly 126 at the greatest operational distance contemplated for a particular application, without requiring an excessive flow of electrical current that would tend to overheat coil assembly 126.

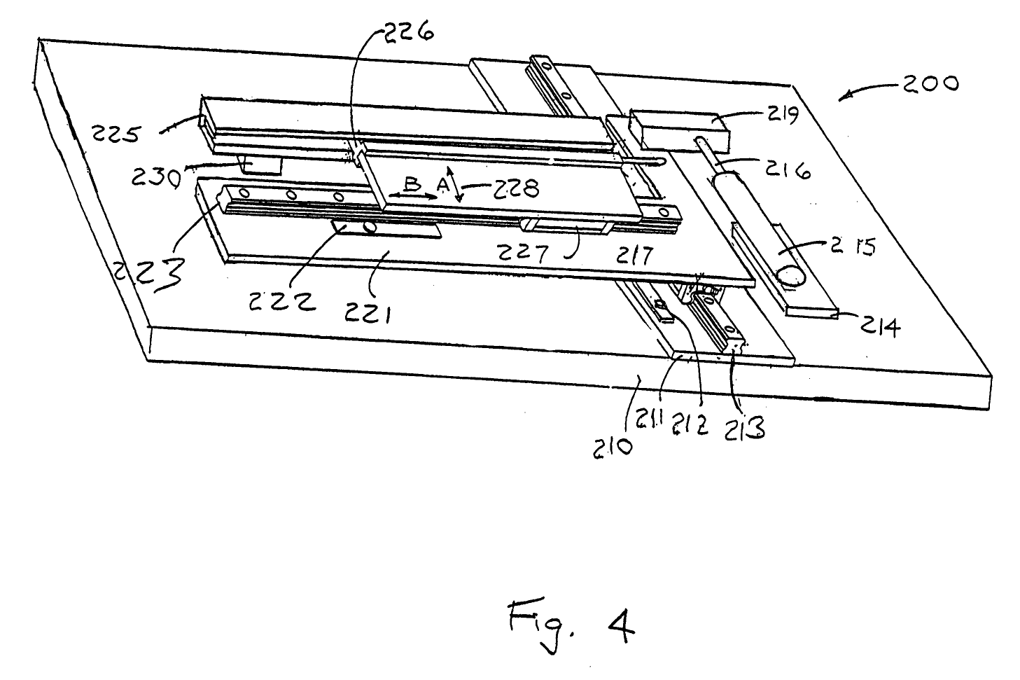

The invention can be practiced utilizing various types of linear drivers such as, for example, a hydraulic piston, a gas-powered piston, or a mechanical linkage as a driver for axis B, rather than the first linear motor as shown in FIG. 3. For example, driver 200 depicted in FIG. 4 includes a double action pneumatic cylinder and piston 215 to drive rod 216 forward and back along the first axis. Block 219 attaches rod 216 to platform 221. With the exception of components 215, 216 and 219, components depicted in FIG. 4 that have the same two final digits as components depicted in FIG. 3 correspond to those components and their descriptions. The cylinder, piston and rod assembly produces a motion for platforms 221 and 228 parallel to axis A, as the first linear motor did.

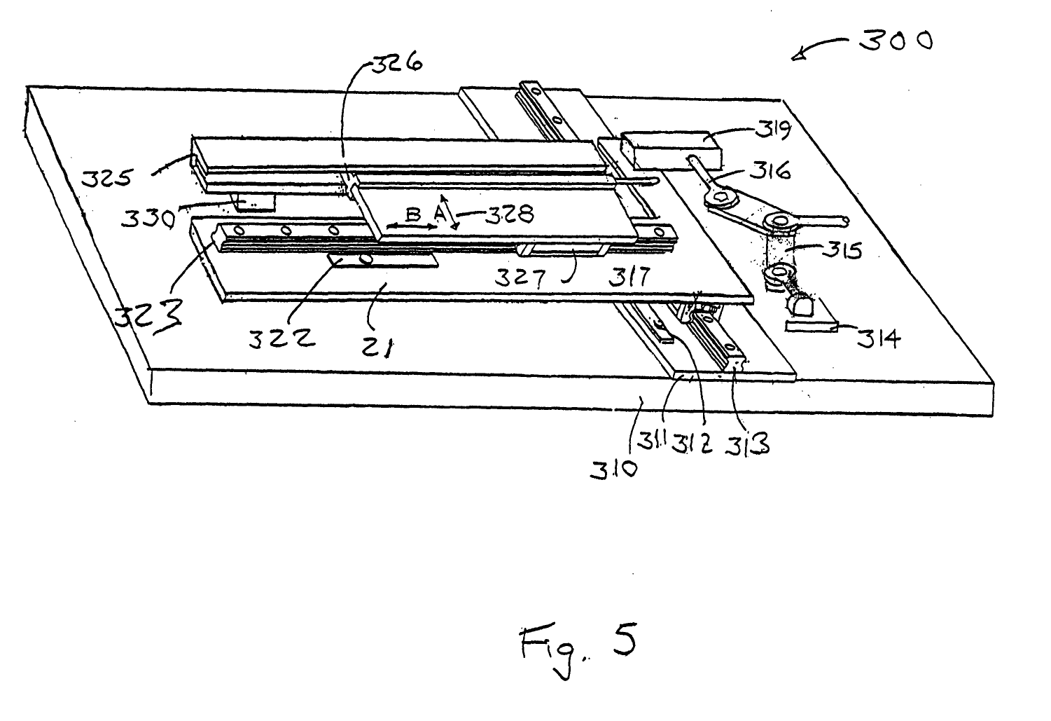

As another example, driver 300 depicted in FIG. 5 includes a mechanical linkage 315 actuated by movement in the direction of second axis B to drive rod 316 forward and back along axis A. This produces motion for the platforms 321 and 328 parallel to axis A, as the first linear motor did. With the exception of components 315, 316 and 319, components depicted in FIG. 5 that have the same two final digits as components depicted in FIG. 3 correspond to those components and their descriptions.

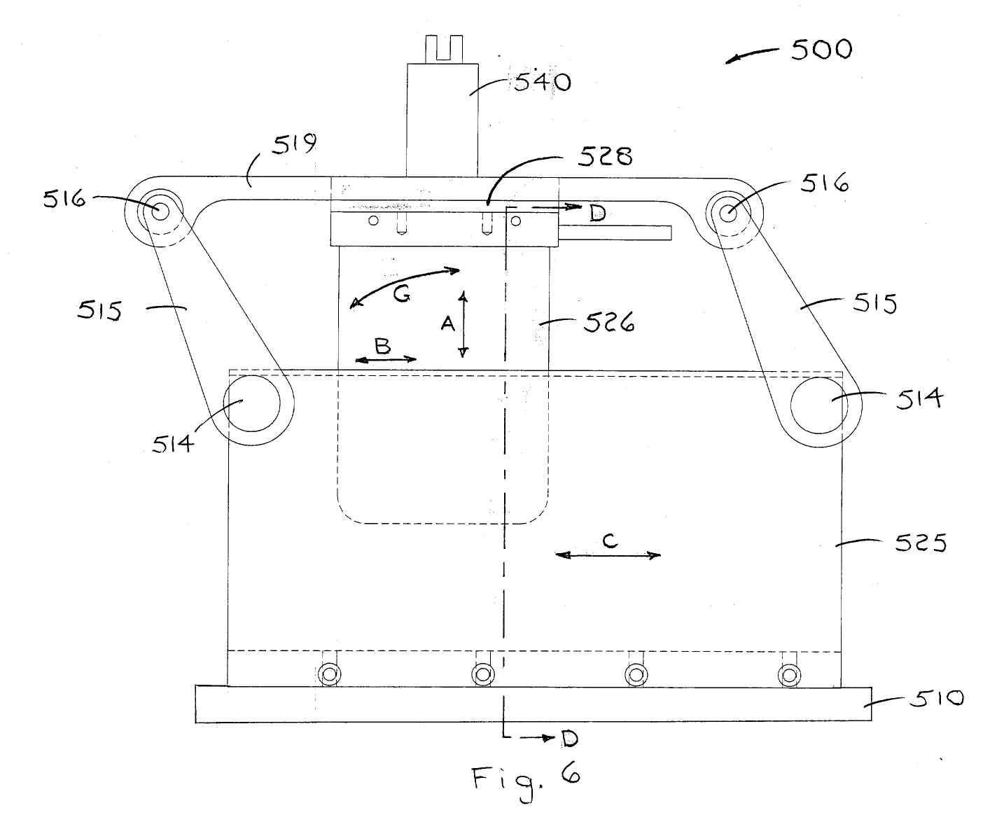

In another embodiment, the invention is biaxial driver 500 comprising magnet assembly 525 and coil assembly 526, as depicted in FIG. 6. With the exception of components 514, 515, 516 and 519, components depicted in FIG. 6 that have the same two final digits as components depicted in FIG. 3 correspond to those components and their descriptions. Magnet assembly 525 includes a row of permanent magnets (not shown) fixed to base 510 and arranged with alternating polarity to produce a magnetic field oriented along a longitudinal axis, illustrated by line C in FIG. 6. Coil assembly 526 is shaped and sized to operate throughout a range of distance from the longitudinal axis of the magnet and to produce, when electrically energized, a motive force parallel to axis B of FIG. 6. As can be seen from FIG. 6, axes B and C are parallel to each other in this embodiment.

Two pivoting links 515 are each pivotally connected to magnet assembly 525 and cross-bar 519 by lower pivot points 514 and upper pivot points 516, respectively. Because cross-bar 519 is fixed to coil assembly 526, links 515 guide coil assembly 526 and platform 528 as they move under the influence of the motive force. Coil assembly 526 moves along an arcuate path, indicated by arrow G, when electrically energized because pivot links 515 move between the horizontal and vertical positions. Of course, the movement of coil assembly 526 is a vector quantity that can be expressed as the sum of motion along two perpendicular axes, such as axis A and axis B. Tool or workpiece 540, which is fixed to coil assembly 526 via platform 528, can be precisely and accurately positioned along the arcuate path indicated by arrow G.

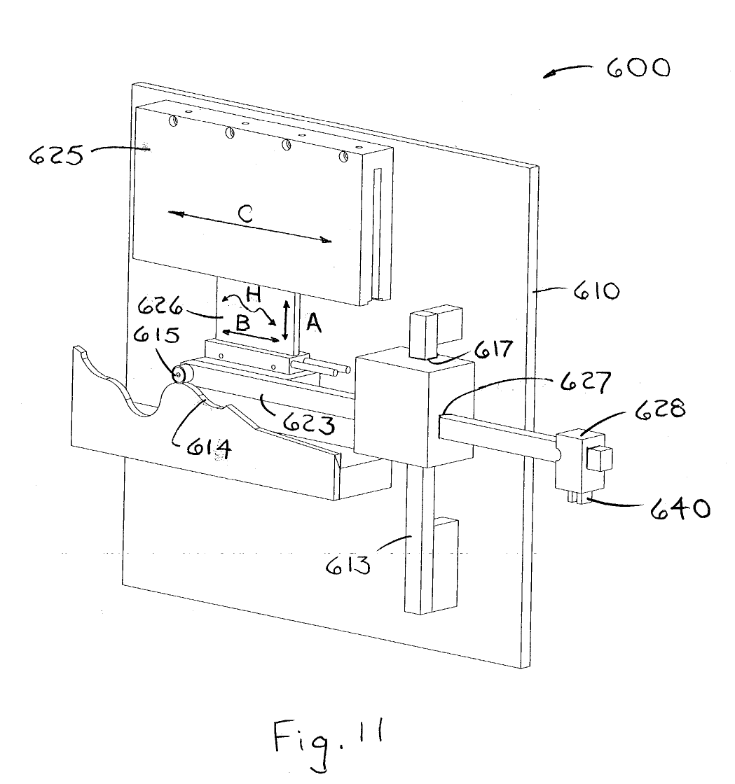

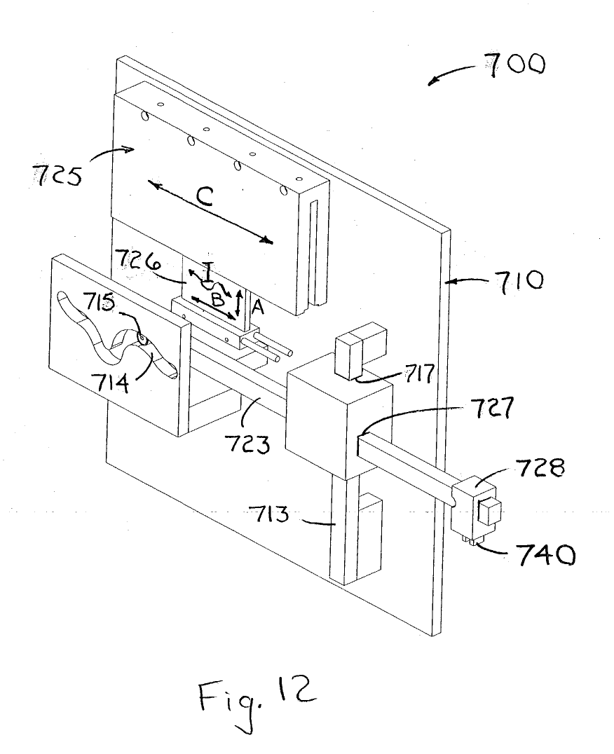

In other embodiments of the invention, various nonlinear drivers are employed to guide coil assembly 526 as it moves under the influence of magnet assembly 525. For example, the nonlinear driver may be a cam and a follower, generally as depicted in FIG. 11. As another example, the nonlinear driver may be a guide and a tongue, generally as depicted in FIG. 12.

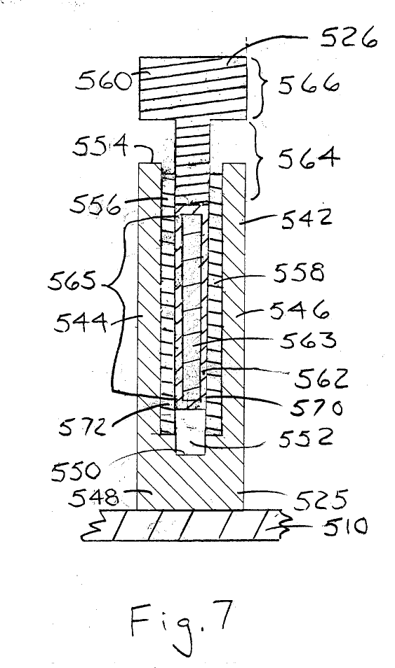

Details of magnet assembly 525 and coil assembly 526 are presented in FIG. 7. Magnet assembly 525 includes magnet support yoke 542 and two sheets or rows of magnets 556, 558. Yoke 542 is attached to base 510 and includes two opposed side plates 544, 546 and end 548, the side plates and the end cooperating to define a cavity between them. The cavity extends from floor 550 to shoulder 554, which are both surfaces of yoke 554. Magnet rows 556, 558 adjoin side plates 544, 546, respectively and each magnet row includes a plurality of permanent magnets arranged with alternating polarity so that magnetic poles of opposite polarity face each other across the cavity.

Coil assembly 526 includes moving coil 560, which is divided into energizable portion 565, mounting portion 564, and bracket portion 566. Energizable portion 565 includes copper conductors 563 molded inside electrically insulating resin binder 562. Sides 570, 572 of energizable portion 565 are generally flat, approximately parallel to each other and spaced to fit loosely within the cavity. Air gap 552 is a variable distance measured from floor 550 to energizable portion 565, when it is inserted into the cavity. As depicted in FIG. 7, coil assembly 526 is in an intermediate position with respect to floor 550. By volume, energizable portion 565 is predominantly electrically conductive material, preferably at least 70 percent conductive material, and more preferably about at least 90 percent conductive material. For the present purposes, “electrically conductive material” means material that is at least as electrically conductive as wrought iron.

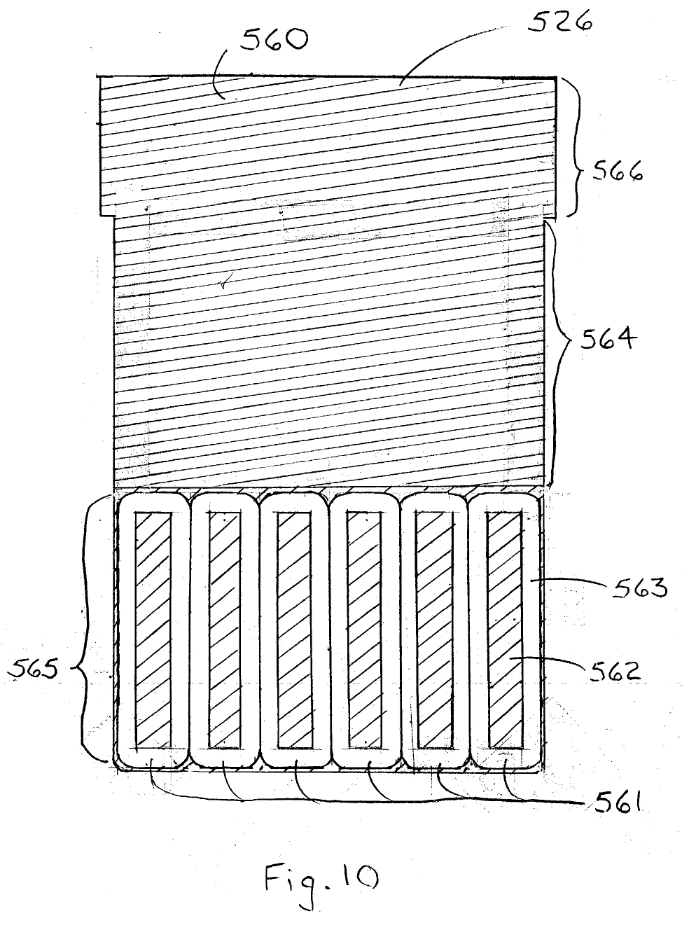

Mounting portion 564 is primarily a structural member, contains little or no electrically conductive material and is substantially nonconductive. Mounting portion 564 generates little or no motive force when exposed to the magnetic field of magnet assembly 525. Preferably, mounting portion 564 is composed predominantly of electrically insulating material, also termed dielectric material, more preferably at least 70 percent by volume electrically insulating material. Preferably, mounting portion 564 includes essentially no electrically conductive coil loops, such as coil loops 561 (best seen in FIG. 10). For the present purposes, “essentially no electrically conductive coil loops” means so few coil loops that any motive force generated by them is too small to change the essential operation of an associated coil assembly, such as coil assembly 525.

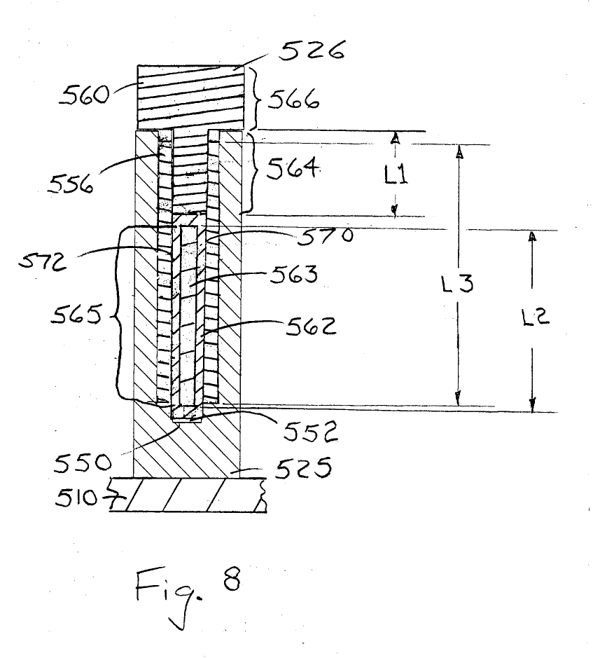

Mounting portion 564 is attached to energizable portion 565, and has a thickness appropriate for insertion into the cavity. Preferably, the thickness of mounting portion 564 is about equal to or less than the thickness of energizable portion 565. The length of mounting portion 564, which is illustrated as L1 in FIG. 8, is preferably at least about one-quarter of the length of energizable portion 565; more preferably, at least about one-half; and, most preferably, about equal to or greater than the length of energizable portion 565, which is illustrated as L2 in FIG. 8.

Bracket portion 566 is attached to mounting portion 564 primarily for the purpose of providing a surface for attaching other components, such as a tool, workpiece or platform, and is often made of the same material as, and integral with, mounting portion 564. Depending on the nature of the tool, workpiece or platform to be moved by coil assembly 526, bracket portion 566 may be unnecessary in some applications.

FIG. 8 depicts coil assembly 526 in a minimally extended position, with respect to floor 550. This position occurs, for example, when pivot links 515 (best seen in FIG. 6) are at their closest approach to horizontal. Coil assembly 526 may be below the longitudinal axis C of the magnetic field at this point. However, because conductors 563 are still between magnet rows 556, 558, coil assembly 526 continues to generate a satisfactory amount of motive force parallel to the longitudinal axis C and exhibits no indications of overheating. The length of magnet rows 556, 558 is indicated by L3 in FIG. 8.

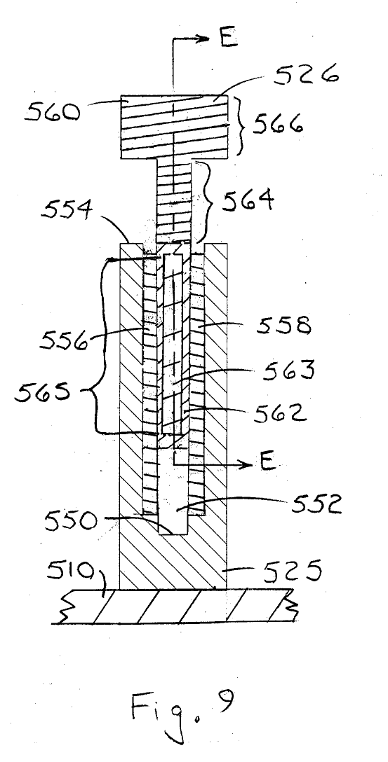

Coil assembly 526 is greatly extended from floor 550, as depicted in FIG. 9. This extension may occur, for example, when links 515 are vertical. When coil assembly 536 moves away from floor 550 during operation, it continues to generate sufficient motive force without overheating. As can be seen in FIG. 9, air gap 552 is significantly increased, as compared to FIG. 8, while conductors 563 remain between magnet rows 556, 558.

FIG. 10 depicts a cross-section taken along B-B of FIG. 9, illustrating that conductors 563 include six nonoverlapping, polyphasic coil loops 561. The size and placement of coil loops 561 determine the dimensions of energizable portion 565. Coil loops 561 are configured in three sets, each set being appropriate for energizing by one phase of a three-phase, 240 volt electrical current. The, width of each of coil loops 561 is calculated to cooperate with the size and arrangement of permanent magnets in magnet rows 556, 568 so that at least one coil loop 561 of each set is always generating motive force while the electrical current is on. U.S. Pat. No. 6,348,746 B1, issued to Fujisawa et al., describes field magnets and polyphasic armature coils and is hereby incorporated by reference.

Additionally, the relative size and number of permanent magnets and coil loops 561 is calculated using widely known principles so that the desired amount of motive force is generated by coil assembly 526 without overheating at various positions of extension and retraction of coil assembly 526 with respect to floor 550. The invention is not limited to operation with energizable portion 565 entirely between magnet rows 556, 568. It is contemplated that the permanent magnets and energizable portion 565 may be sized and constructed so that energizable portion 565 may be operated at least partially above or below magnet rows 556, 568.

In still another embodiment, the invention includes biaxial driver 600 comprising magnet assembly 625 and coil assembly 626, as depicted in FIG. 11. With the exception of components 614 and 615, components depicted in FIG. 6 that have the same two final digits as components depicted in FIG. 3 correspond to those components and their descriptions. Magnet assembly 625 includes a row of permanent magnets (not shown) fixed to base 610 and arranged with alternating polarity to produce a magnetic field oriented along a longitudinal axis, illustrated as axis C. Coil assembly 626 is shaped and sized to operate throughout a range of distance from axis C and to produce, when electrically energized, a motive force parallel to axis B. As can be seen from FIG. 11, axes B and C are parallel to each other in this embodiment.

Cam 614 is rigidly attached to base 610 and, consequently, is fixed with respect to magnet assembly 625. Follower 615 is attached to coil assembly 626. The force of gravity holds follower 615 against surface 619 of cam 614 as coil assembly 626 is propelled along axis B by the motive force. Coil assembly 626 moves along axis A under the influence of follower 615 as it follows the surface of cam 614. Accordingly, the actual path of coil assembly 626 and platform 628 is described by curve H, which parallels surface 619 of cam 614. Guide rail 613 glides along bearing 617. Guide rail 623 glides along bearing 627. The bearings 617, 627 are located in bearing block 618. Tool or workpiece 640, which is fixed to coil assembly 626 via platform 628, can be precisely and accurately positioned along the arcuate path indicated by arrow H.

In yet another embodiment, the invention includes biaxial driver 700 comprising magnet assembly 725 and coil assembly 726, as depicted in FIG. 12. With the exception of components 714 and 715, components depicted in FIG. 6 that have the same two final digits as components depicted in FIG. 3 correspond to those components and their descriptions. Coil assembly 726 is shaped and sized to operate throughout a range of distance from axis C of the magnet and to produce, when electrically energized, a motive force parallel to axis B. As can be seen from FIG. 12, axis B is parallel to axis C, which is the longitudinal axis of magnet assembly 625.

Serpentine groove or track 714 is formed in block 720, which is rigidly attached to base 710 and, consequently, is fixed with respect to magnet assembly 725. Tongue 715 is attached to coil assembly 726 and inserted into groove 714. The position of tongue 715 with respect to axis A is limited by groove 714. As coil assembly 726 is propelled along axis B by the motive force, coil assembly 726 moves along axis A under the influence of tongue 715 as it tracks the inner surface 719 of groove 714. Accordingly, the actual path of coil assembly 726 and platform 728 is described by curve I, which parallels groove 714. The bearings 717, 727 are located in bearing block 718 to support the guide rail 713, 23, respectively.

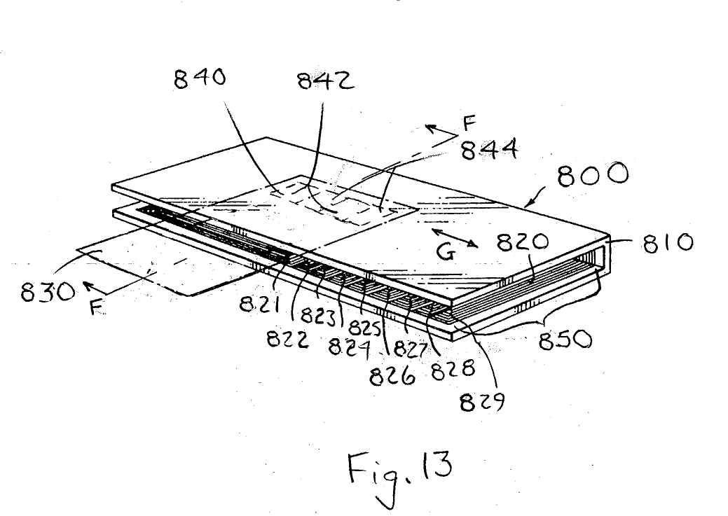

While the invention has been described above by reference to a stationary magnet and a moveable coil, the invention may also be practiced with a stationary linear coil and moving magnet, as depicted in FIG. 13. Coil and extensible magnet assembly 800 includes a coil support yoke 810 for supporting conductors 820, which have a plurality of electrically energizable coil loops 821-829. When energized, conductors 820 produce an electromagnetic field along longitudinal axis G. Although coil loops 821-829 are depicted in FIG. 11 as overlapping one another, nonoverlapping coils may also be successfully employed in conductors 820, provided that the electrical current is commutated in accordance with well-known principles.

Continuing with FIG. 13, assembly 800 also includes extensible magnet assembly 830 having at least one row of magnets 840 arranged side-by-side in alternating polarity to produce a magnetic field in the longitudinal axis. Specifically, magnets 842 having north poles facing upwardly alternate with magnets 844 having south poles facing upwardly to produce magnetic flux that varies sinusoidally as a function of distance in the longitudinal axis. U.S. Pat. No. 4,051,398, issued to Kondo, describes rectangular and U-shaped coils for driving a movable magnet member and is hereby incorporated by reference.

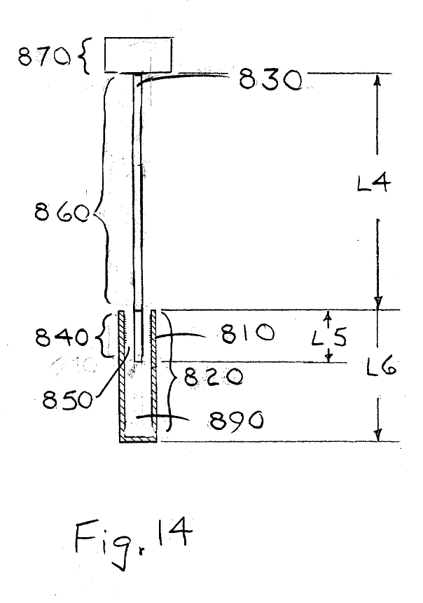

FIG. 14 is a cross-sectional view taken along C-C in FIG. 13, which shows electromagnetic field region 850 concentrated between conductors 820. Magnet assembly 830 is inserted between conductors 820 so that magnet rows 840 reside in electromagnetic field region 850. Variable air gap 890 is located between magnet rows 840 and yoke 810.

Mounting portion 860 is primarily a mechanical support member and is substantially nonmagnetic. Preferably, mounting portion 860 includes essentially no magnets. As can be seen in FIG. 14, mounting portion 860 is attached to magnet rows 840 and has a length that is illustrated as L4. Bracket portion 870 is attached to mounting portion 860.

To operate assembly 800, conductors 820 are energized with electrical current by a commutator in accordance with well known principles to produce an electromagnetic field along longitudinal axis G. The electromagnetic field interacts with magnetic field produced by magnet rows 840, generating a motive force generally parallel to longitudinal axis G. Because the length of electromagnetic field region 850, which is illustrated as L6 in FIG. 14, is greater than the length of magnet rows 840, which is illustrated as L5 in FIG. 14, magnet assembly 830 can be extended away from or retracted toward longitudinal axis G over a significant range of distance without excessive heat or unacceptable loss of motive force.

It is also contemplated that the invention can produce movement along three axes by, for example, utilizing an extensible coil and one or two linear electric motors. With three motors, the first axis magnet assembly may be fixed relative to the second axis magnet assembly so that the second axis coil assembly (which includes an extensible coil) operates in an extended position relative to the second magnet assembly.

Alternatively, the second axis magnet assembly may be fixed relative to the third axis magnet assembly so that the third axis coil assembly (which includes an extensible coil) operates in an extended position relative to the third magnet assembly. Those who study this application will find that it suggests other arrangements, which are also intended to be within the scope of the invention. The figures and descriptions set forth above are intended to be exemplary only and not to limit the scope of the appended claims.

That which is claimed is:

1. A coil assembly for producing a motive force, the coil assembly comprising:
an energizable portion including a plurality of electrically conductive coil loops that generate a motive force generally parallel to a longitudinal axis when the coil loops are energized in a magnetic field arranged along a longitudinal axis;
a substantially nonconductive mounting portion attached to the energizable portion, the mounting portion having a thickness about equal to or less than the thickness of the energizable portion and a length of at least about one-quarter of the length of the energizable portion.

2. The coil assembly of claim 1 in which the energizable portion includes two generally flat and parallel sides.

3. The coil assembly of claim 1 in which the energizable portion includes three sets of coil loops.

4. The coil assembly of claim 1 in which the coil loops are predominantly nonoverlapping.

5. The coil assembly of claim 1, which further comprises a bracket attached to the mounting portion.

6. A biaxial driver, which comprises:
a magnetic field arranged along a longitudinal axis;
a coil assembly including a plurality of electrically conductive coil loops that generate a motive force for moving the coil assembly generally parallel to the longitudinal axis, when the coil loops are electrically energized in the magnetic field; and
a cross driver for moving the coil assembly along an axis that crosses the longitudinal axis.

7. The biaxial driver of claim 6 in which the crossing axis is inclined at an interior angle of about one to about ninety degrees relative to the longitudinal axis.

8. The biaxial driver of claim 6 in which the cross driver is a non-linear driver.

9. The biaxial driver of claim 8 in which the cross driver includes a pair of pivoting links, each of the links being pivotally connected to the row of magnets and to the coil assembly.

10. The biaxial driver of claim 8 in which the cross driver includes a cam connected to the row of magnets and a follower connected to the coil assembly.

11. The biaxial driver of claim 8 in which the cross driver includes a guide groove connected to the row of magnets and a tongue connected to the coil assembly.

12. The biaxial driver of claim 6 in which the cross driver includes a linear driver that is attached to the coil assembly.

13. The biaxial driver of claim 12 in which the linear driver is a linear electric motor.

14. The biaxial driver of claim 12 in which the linear driver is a piston.

15. The biaxial driver of claim 12 in which the linear driver is a mechanical linkage.

16. The biaxial driver of claim 6 in which the coil assembly includes a substantially nonconductive mounting portion that is attached to the energizable portion, the mounting portion having a thickness that is about equal to or less than the thickness of the energizable portion and a length that is at least about one-quarter of the length of the energizable portion.

17. A biaxial driver for positioning a platform in a plane, which biaxial driver includes:
a first magnet assembly that produces a magnetic field arranged along a longitudinal axis;
a first coil assembly including an energizable portion having a plurality of electrically conductive coil loops that generate a force for moving the first coil assembly generally parallel to the longitudinal axis, when the first coil loops are energized in the magnetic field of the first magnet, and a substantially nonconductive mounting portion attached to the energizable portion;
a second magnet assembly that is fixed relative to the first magnet assembly and produces a magnetic field arranged along an axis that crosses the longitudinal axis;
a second coil assembly including a plurality of electrically conductive coil loops that generate a force for moving the second coil assembly along the crossing axis, when the second coil loops are energized in the magnetic field of the second magnet assembly; and
a platform fixed to the second coil assembly so that the platform is positionable in a plane defined by the longitudinal axis and the crossing axis.

18. The biaxial driver of claim 17 which includes a substantially nonconductive mounting portion that is attached to the energizable portion and has a thickness that is about equal to or less than the thickness of the energizable portion and a length that is at least about one-quarter of the length of the energizable portion.

19. The biaxial driver of claim 17 in which the length of the first magnet assembly is at least about one quarter greater than the length of the energizable portion.

20. The biaxial driver of claim 17, which further comprises
a first bearing that is attached to the platform;
a first guide channel oriented generally parallel to the longitudinal axis, the first bearing gliding along the first guide channel;
a second guide channel, which is fixed with respect to the first magnet assembly and oriented generally parallel to the crossing axis;
a second bearing that glides along the second guide channel and is attached to the second coil assembly; and
a second platform that is attached to the second coil assembly, the second bearing and the first guide channel.

21. A biaxial driver, which comprises:
a magnet assembly including permanent magnets arranged with alternating polarity to produce a magnetic field arranged along a longitudinal axis;
a coil assembly including a plurality of electrically conductive coil loops that generate a motive force generally parallel to the longitudinal axis when the coil loops are energized in the magnetic field; and
a cross driver for moving the magnet assembly or the coil assembly along an axis that crosses the longitudinal axis.

22. The biaxial driver of claim 21, in the which the length of the coil assembly is at least about one-fourth greater than the length of the magnet assembly, or
the length of the magnet assembly is at least about one-fourth greater than the length of the coil assembly.

23. The biaxial driver of claim 21, in the which
the magnet assembly includes a substantially nonmagnetic mounting portion for moving the magnet assembly along the intersecting axis, the nonmagnetic mounting portion being attached to the magnetic portion and having a thickness that is about equal to or less than the thickness of the magnetic portion and a length that is at least about one-quarter of the length of the magnetic portion; or
the coil assembly includes a substantially nonconductive mounting portion for moving the coil portion along the intersecting axis, the nonconductive mounting portion being attached to the energizable portion and having a thickness that is about equal to or less than the thickness of the energizable portion and a length that is at least about one-quarter of the length of the energizable portion.

24. The biaxial driver of claim 21 wherein the a magnet assembly includes a substantially nonmagnetic mounting portion attached to the permanent magnets and a thickness about equal to or less than the thickness of the magnetic portion and a length of at least about one-quarter of the length of the magnetic portion.

25. A magnet assembly for producing a magnetic field arranged along a longitudinal axis, the magnetic field being of appropriate size and shape to generate a motive force generally parallel to the longitudinal axis in cooperation with a plurality of electrically energized coil loops generally arranged along a plane, the magnet assembly comprising:
a magnetic portion having a row of permanent magnets arranged in alternating polarity to produce magnetic field arranged along a longitudinal axis; and
a substantially nonmagnetic mounting portion attached to the magnetic portion, the mounting portion having a thickness that is about equal to or less than the thickness of the magnetic portion and a length of at least about one-quarter of the length of the magnetic portion.

26. The magnet assembly of claim 25, in which the magnetic portion includes two generally flat and parallel sides.

27. The magnet assembly of 25, which further comprises a bracket attached to the mounting portion.
